(19) United States
(12) Patent Application Publication
(10) Pub. No.: US 2004/0162777 A1
(43) Pub. Date: Aug. 19, 2004

(54) Method of apportioning investments within a multi-country fund

(76) Inventors: James L. Sullivan, Hockley, TX (US); Charles L. Fahy SR., Sugar Land, TX (US)

Correspondence Address: WONG, CABELLO, LUTSCH, RUTHERFORD & BRUCCULERI,, P.C., 20333 SH 249, SUITE 600, HOUSTON, TX, 77070, US

(21) Appl. No.: 10/367,328

(22) Filed: Feb. 14, 2003

(51) Int. Cl. G06F 17/60

(52) U.S. Cl. 705/37; 705/36

(57) ABSTRACT

A method of allocating investments in an international mutual fund is based on the gross national product of each country represented in the fund. In one embodiment, the gross national products of the countries represented in the fund are summed. The percentage that each country's gross national product contributes to the sum of gross national products is then computed. An investment is made which is approximately the same percentage of the fund in each country represented in the fund as that country's gross national product contributes to the sum of gross national products.

### BACKGROUND OF THE INVENTION

1. Field of the Invention

The invention relates to mutual funds and other such pooled-interest investment vehicles.

2. Description of the Related Art

A mutual fund is an enterprise that pools funds from customers and invests them in a portfolio, typically of securities and theoretically in keeping with the goals and principals stated in the fund's prospectus.

Mutual funds are increasingly the vehicle of choice for lay investors seeking a return on their savings. One reason is the staggering array of choices offered by the mutual fund industry. There are funds of every conceivable variety and risk level, but they fall into a few broad categories. Stock funds might be considered value or growth; the former are more conservative than the latter. Looked at a different way, stock funds also specialize in small, medium or large size firms, or firms in a particular sector, such as computers or health care or financial services. There are also many kinds of bond funds, as well as funds that invest in a mix of stocks and bonds. Most funds are professionally managed, but some index funds are run more or less by computer, since they seek only to match a market index, such as the Standard & Poor's 500. Finally, there are money-market funds, which many people don't even think of as mutual funds.

Most funds are “open end” funds, but some are “closed end,” meaning they trade like stocks from investor to investor. A fund that is open to new investors where both new investors and existing shareholders may purchase as many shares as they want. In an open-ended mutual fund, the fund grows as more money comes in. When investors sell, the number of outstanding shares drops.

Occasionally, open-end funds are closed to new investors when they become too large and difficult to manage. However, current shareholders in the fund can continue to invest money. Conversely, a closed-end fund raises money only once, offers a fixed number of shares, and these shares are traded on exchanges much like stocks. Most mutual funds are open-end funds, and sell as many shares as investors want. Investors who want to sell redeem their shares through the fund.

The Net Assets of a fund (typically recorded in millions of dollars) represents the fund's total asset base, net of fees and expenses.

The Net Asset Value (NAV) is the current value of a share in a mutual fund. It is the fund's assets minus liabilities divided by the number of outstanding shares. Most funds calculate their NAV after the close of trading each day. For conventional mutual funds, a share is worth the day's NAV, but in closed-end mutual funds, the NAV and the market price aren't usually the same. That's because closed-end fund shares trade like stocks, from investor to investor, and sell at a premium or discount to their NAV, depending on a variety of factors (such as transaction costs and investor expectations).

Asset Allocation is an investment strategy wherein the investor decides what percentage of his or her investment portfolio should go into stocks, bonds, or other asset classes. After the investor sets up his or her portfolio based on the particular asset allocation strategy, he or she must adjust their holdings on a regular basis to maintain these percentages. The asset allocation model one chooses is typically based on how much risk one is willing to take.

An Asset Allocation Fund is a fund designed to provide the diversification needed to weather virtually any market or economic environment. Most of these funds have been created over the past five or six years. They typically invest in a variety of assets: domestic stocks, foreign stocks, bonds, and money market instruments, investments that one would normally buy in separate funds. Many 401(k) plans now offer several asset allocation funds, each with a different investment mix and risks ranging from the very conservative to the very speculative.

The total cost for all shares of an investment divided by the number of shares held is known as the Average Cost. An investor can average up or average down, depending on the direction of prices and his or her faith in a given company.

Annual Return on investment is calculated by taking the value of the investment held at the beginning of the Return on Investment (ROI) period compared to the current value. In other words:

((Current Value)−(Beginning Value)+(Income))/(Beginning Value), where

(Current Value)=(the current total shares)×(the last price),

(Beginning Value)=(number of shares held prior to the period−any shares sold)×(the closing price prior to the period)+the “Cost Basis” of any shares added in this period (Buys, Reinvest, Add Shares, etc), and

(Income)=any income events such as Dividends/Interest (not Reinvested) and Realized gain/loss from Sells in this period.

Gross National Product (GNP) of a particular country is the (dollar) value of all goods and services produced in that nation's economy, including goods and services produced abroad.

Gross Domestic Product (GDP) is the total value of goods and services produced by a nation within that nation.

International Funds are mutual funds that invest in stocks and/or bonds of companies outside the United States. International funds pose some unusual risks. In addition to choosing the most promising foreign companies, fund managers must also hedge against currency fluctuations and sometimes must even consider political unrest.

The term Regional Fund is generally used to designate a mutual fund that focuses on a particular part of the world, such as Europe or the Pacific Rim. Some of today's regional funds specialize in buying stock in companies headquartered in a particular part of a country—for example, the Midwest or Southeast U.S.—or derive most of their business from those regions.

International Hybrids are a category for international equity funds that invest at least 20% but less than 70% of their portfolio in stocks, with at least 40% of all stock and bond investments in foreign countries. These funds diversify investments across several countries and regions, presenting less risk than a regional fund because the financial markets of different countries don't always move the same way.

Real Estate Investment Trusts (REITs) are sort of like mutual funds, except they invest in real estate (or mortgages) and pay out almost everything they earn (less the usual management fees) to shareholders. There are REITs that specialize in apartment buildings, shopping centers, office structures, nursing homes, various regions of the country, and any or all of the above. Although REITs may experience strong capital appreciation, REITs are invariably dividend-paying stocks.

Guaranteed Investment Contracts are contracts that pay a fixed interest rate for a fixed term, typically one to five years. A GIC fund—often called a stable value fund or an insurance contract fund—buys GICs from many different insurers. A GIC fund invests only in guaranteed investment contracts (GICs). The contracts are issued by insurance companies and sold only to pension plans and certain other types of retirement funds. The insurer, not the government, guarantees the contracts themselves.

### BRIEF DESCRIPTION OF THE DRAWINGS

FIG. 1 is a tabulation of a hypothetical world showing the percentage contribution of each country to the world aggregate product and the resulting participation of a mutual fund in each country.

FIG. 2 is a tabulation of one embodiment's application to a hypothetical world comprised of 12 countries.

FIG. 3 is a table of threshold values of contribution change which, in one embodiment, are used to trigger a rebalancing of the fund.

FIG. 4 is a tabulation of another embodiment's application to a hypothetical world comprised of 12 countries.

### DETAILED DESCRIPTION

Diversification is an investing strategy that seeks to minimize risk by diversifying among many types of investments. Diversification and risk are directly related to each other because the more a portfolio is diversified, the less the risk to that portfolio.

There are many ways to diversify an investment portfolio. By way of example, one may diversify equity investments among different industry sectors (e.g., technology, manufacturing, chemicals, utilities, etc.), among asset classes (e.g., equity, fixed income, real estate, precious metals, etc.) and among countries or geographic regions (e.g., United States, North America, Pacific Rim, European Union, etc.).

One, particularly preferred investment strategy for those seeking to minimize risk and maximize their participation in the growth of the world's economy is to diversify both by asset class and geography. Within asset classes, diversification can be made by industry sector or in other conventional ways. However, until now there has not been a defined method of allocating investments among the various countries of the world which takes into account the effect of each country's economic activity on the world's total economy.

The method of the present invention allocates investments within a particular country based upon that country's percentage contribution to the total production of all goods and services produced in the world. We here define the Total World Product (TWP) to be the sum of the GNP's of all the countries of the world. At present, the world is comprised of about 200 countries. As a practical matter, however, only about 100 countries have economies which are of sufficient size to affect the TWP within the margin of error—i.e., the political boundaries of the world are never completely static and many smaller and less developed countries do not have reliable means for gathering and reporting economic data. One may therefore define a subset of the world's countries as the investment universe and sum their GNP's to produce a working TWP. For any country N, the percentage contribution of N's economy to the TWP will be 100×GNPₙ/TWP. This figure may be used to apportion the investment of the fund in assets located in or associated with country N.

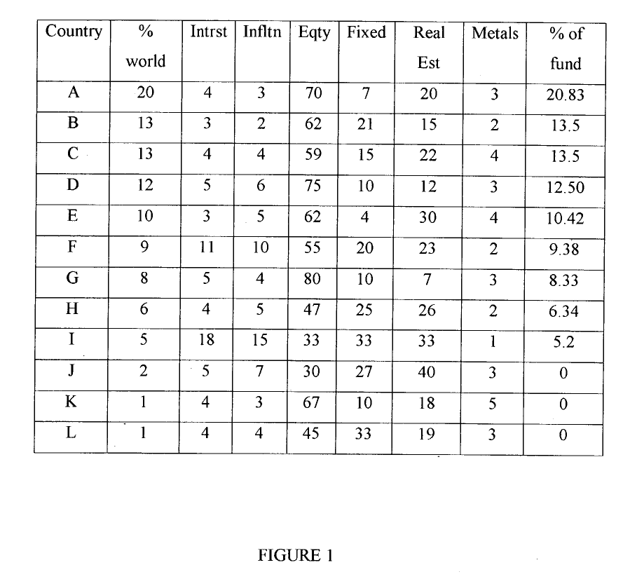

FIG. 1 is a tabulation of a hypothetical world comprised of 12 countries showing each country's percentage contribution to TWP, the prevailing interest rate in the country, the prevailing rate of inflation in the country and the percentage each of equity investments, fixed income investments, real estate and precious metals contributes to that country's economy. In the rightmost column is shown the percentage of the total fund that would be invested in that country in one particular embodiment of the present invention. In the particular embodiment illustrated, a threshold value of 5% of TWP has been chosen for participation in the fund—i.e., countries whose economies individually contribute less than 5% to the world's economy are excluded from the fund. The assets of the fund are distributed among the remaining countries—i.e., those whose GNP is greater than or equal to 5% of TWP—on the basis of their contribution to TWP. For example, in the hypothetical situation illustrated in FIG. 1, Country A contributes 20% to TWP, but Countries J, K and L are excluded from the fund owing to their GNP's being less than the chosen threshold value of 5%. Thus, investment in Country A would be 20/96=20.83 percent since 96% of TWP is represented in the fund.

Due to rounding errors, the sum of percentages shown to four significant figures may not total exactly 100%. Accordingly, it may be necessary to adjust the percentages to achieve a 100% sum. In the embodiment illustrated, the percentages for Countries B, C and I have been adjusted to provide a sum of 100.00%

Even within the 100 or so significant economies, some comprise less than 1% of the TWP. For administrative convenience, in another embodiment, countries having GNPs less than a threshold percentage of TWP are pooled into a single subfund with investments within the pool apportioned by each country's percentage contribution to the pool.

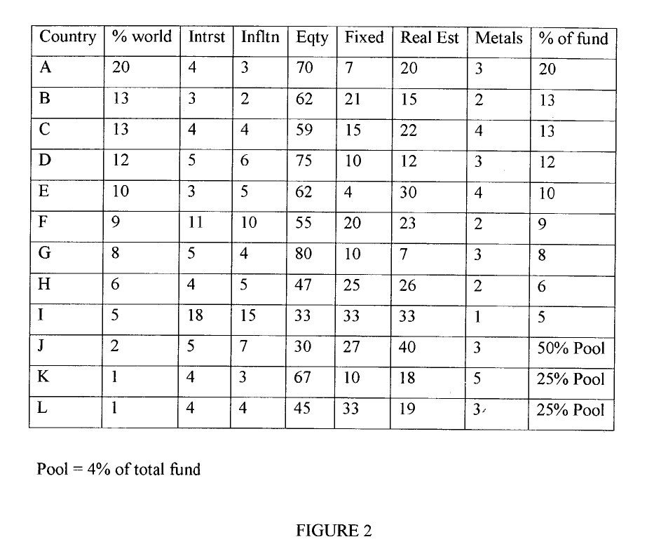

FIG. 2 is a tabulation of a hypothetical world comprised of twelve countries. The percentage that each country contributes to the TWP is shown in the second column. In the particular embodiment illustrated, countries contributing less than 5% to the TWP are assigned to a pool. It will be noted that countries J, K and L are each less than the threshold amount and therefore are assigned to a pool which, in total, represents 4% of TWP. Within the pool, country J represents 50% inasmuch as its economy is 2% of TWP and 2% is 50% of the pool total of 4%. Likewise, countries K and L are each 25% of the pool because they are individually 1% of TWP which is one quarter of the pool total.

Within countries (or within country pools), one may apportion investment among asset classes. One representative apportionment is among the four asset classes denominated equity, fixed income securities, real estate and precious metals. Investments within these asset classes may be accomplished in any way. Examples of investment vehicles include direct investment, mutual funds, options and futures. The distribution between equity and fixed income securities, in one embodiment, may be determined by the percentage that each contributes to a particular country's GNP. Similarly, the real estate factor for a given country (or country pool) may be derived from real estate's contribution to that country's GNP. And, the percentage of the investment made in precious metals may be determined by the value of all precious metal values as a percentage of TWP.

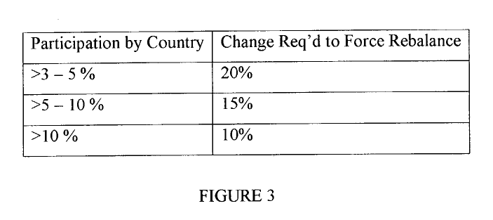

The fund's asset allocations among asset classes and among various countries may, in some embodiments, be rebalanced on a periodic basis—for example, each calendar quarter or semi-annually. Rebalancing is the is the sale of some assets and the purchase of other assets made to adjust for the appreciation or depreciation in asset value which causes the fund allocation to deviate from the asset allocation strategy stated in the prospectus. In some embodiments, the percentage change must exceed a threshold value in order to force a rebalancing. In still other embodiments, a change in the relative value of asset classes within a country or region which exceeds a threshold value at any time will trigger a rebalancing. FIG. 3 is a table which illustrates one particular embodiment's threshold values by the level of a country's participation in the fund.

The rebalance effort must weigh the change in each country's figures between initial calculations and final calculations over the time periods.

For example, using the hypothetical situation illustrated in FIGS. 1 and 2, the fund originally invested 10% of its assets in Country E (FIG. 1). If the investment in Country were to appreciate by more than 15% (FIG. 2), a rebalancing would be initiated either at the next periodic rebalancing or immediately, depending on the particular embodiment chosen.

The determination of a country's GNP, in some embodiments, may be based on data from multiple sources. For example, GNP data is currently provided by Ibbotson Associates, the United States Federal Reserve, the World Bank, the United Nations and the United Bank of Switzerland, among others. In some embodiments, GNP data is pooled from multiple sources to smooth out calculations and eliminate as much as possible any skew that might occur as a result of bias or calculation methodology. Pooling data from multiple sources may also ameliorate the effects of lag that report timing may cause. In some embodiments, the pooled data may be used to calculate a numerical average. In other embodiments, the data may be assigned a weighting factor to account for the reputation or timeliness of the organization reporting the data.

In still other embodiments, other or additional figures of merit relating to a country's contribution to a world total may be used—for example, Gross Domestic Product.

All investors are affected by interest rate risk or the chance that interest rates will change the value of their investment. But interest rates have the greatest impact on bonds. When rates rise, the value of bonds fall. And the longer the term of the bond, the more it falls. So an increase in interest rates will have a much greater impact on a 30-year bond than on a five-year bond. An Interest-Sensitive Stock is a stock whose price is very much affected by rising or falling interest rates. Companies in a number of industries have fortunes tied to rates. Auto makers, home builders, mortgage lenders, financial institutions and others find that when rates soar, their business dries up. But some stocks can show rate sensitivity even in an industry not known for such problems. These are stocks that pay hefty dividends. Such stocks often are purchased specifically for their dividend. When rates fall, this dividend looks even better. But as rates rise, this dividend is less appealing compared to Treasury securities and other riskless investments.

Similarly, inflation risk is the risk that a given country's money will not be worth as much in the future because the cost of goods and services tends to increase. Guaranteed investments like bank accounts do not keep pace with inflation.

In all asset classes' percentage calculation, the current rate of inflation and current level of interest rates in each country versus the average rates for each on a world scale may, in some embodiments, cause a raising or lowering of the respective countries' asset allocation in the fund. If the rates are below the world average, the percentage could increase; if the rates are above the world average, their percentage for each account could be lower. Therefore, the current economic condition in each country could raise or lower the percentage participation in each country that exceeds a threshold rate.

For example, in one embodiment, the inflation rates of all countries represented in the fund are averaged, and if the rate of inflation in any country exceeds the average rate of inflation by more than a threshold value, that country is assigned to the pooled investments. Similarly, investments in countries whose prevailing interest rate exceeds the world average by a threshold amount may also be assigned to the pool. Participation in the pool may be assigned, in some embodiments, to correspond to the contribution made by each participating country to the pool.

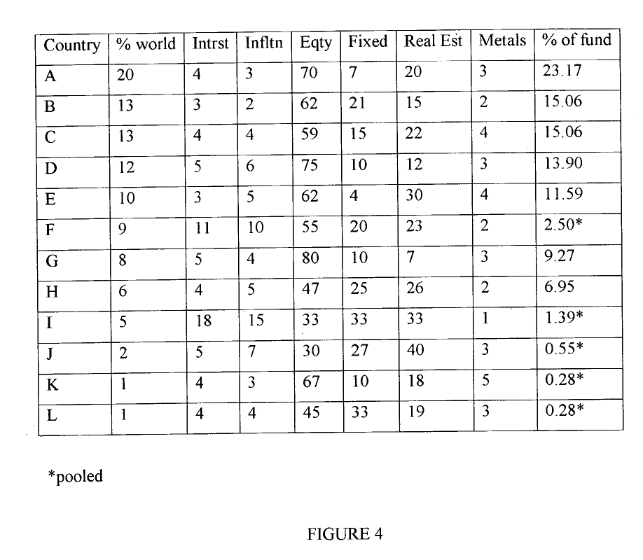

One particular embodiment is shown in FIG. 4 for a hypothetical world comprised of 12 countries. The numerical average interest rate (in percent) is 70/12=5.83. The numerical average rate of inflation (in percent) is 68/12=5.67. If the threshold value for each is defined to be 20% in excess of the average, the threshold value for interest rate is 7.0% and the threshold value for rate of inflation is 6.8% Thus, in the hypothetical example illustrated, the interest rates in Country F and Country I exceed the threshold value and would therefore be assigned to the pool. Likewise, the inflation rates in Country F, Country I and Country J exceed the threshold value for inflation rate and would be assigned to the pool. Note that Country J may also be assigned to the pool on the basis of its contribution to TWP being below the threshold value of 5%—i.e., more than one criterion may be used to place countries in the pool.

In some embodiments, the pool may be limited to a maximum percentage of the total investment. For example, the pooled investments might be limited to a maximum of 5% of the total fund. Each country's contribution to the pool may, in some embodiments, be determined by the percentage each country's GNP contributes to the sum of GNP's of countries in the pool. In the example illustrated, the pool is comprised of Country F, Country I, Country J, Country K and Country L. The sum of these countries' percentage of TWP is 18%. Since Country F represents 9% of TWP, it would represent 9/18=50% of the pool. Similarly Country I would be 5/18=27.8%; Country J would be 2/18=11.1%; and, Country K and Country L would each be 1/18=5.55% of the pool. Thus, if the total value of the fund was $1B, the target investment in Country L would be $2,775,000 (5.55% of 5% of $1B).

If investment in the pool is capped at 5% of the total fund, the remaining 95% of the fund could be apportioned among the non-pooled countries on the basis of their contribution to the sum of the non-pooled economies.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method of allocating investments in an international mutual fund which comprises:
summing the gross national products of the countries represented in the fund;
computing the percentage that each country's gross national product contributes to the sum of gross national products;
investing approximately the same percentage of the fund in each country represented in the fund as that country's gross national product contributes to the sum of gross national products.

2. A method as recited in claim 1 further comprising pooling investments in those countries whose gross national products fall below a pre-selected threshold percentage of the sum of gross national products.

3. A method as recited in claim 1 further comprising apportioning investments within each country represented in the fund among pre-selected asset classes such that the percentage of the total investment of the fund in each country in each asset class is approximately the same as the percentage that each asset class contributes to the total economy of that country.

4. A method as recited in claim 1 further comprising rebalancing the fund at predefined periods.

5. A method as recited in claim 1 further comprising rebalancing the fund if the percentage change in at least one country's representation in the fund changes by more than a preselected amount.

6. A method as recited in claim 1 further comprising pooling investments in those countries whose rates of inflation exceed a threshold value.

7. A method as recited in claim 1 further comprising pooling investments in those countries whose rates of inflation exceed the average rate of inflation by a pre-selected amount.

8. A method as recited in claim 1 further comprising pooling investments in those countries whose interest rates exceed a threshold value.

9. A method as recited in claim 1 further comprising pooling investments in those countries whose interest rates exceed the average interest rate by a pre-selected amount.

10. A method of allocating investments in an international mutual fund which comprises:
selecting a measure Xₙ of the value of goods and services produced by each country N represented in the fund;
summing the values of Xₙ for each of the countries represented in the fund;
computing the percentage that each country's Xₙ value contributes to the sum of Xₙ values;
investing approximately the same percentage of the fund in each country represented in the fund as that country's Xₙ value contributes to the sum of Xₙ values.

11. A method as recited in claim 10 wherein the measure Xₙ of the value of goods and services produced by each country N includes the value of goods and services produced by country N outside of its territorial borders.

12. A method as recited in claim 10 wherein the measure Xₙ of the value of goods and services produced by each country N includes only the value of goods and services produced by country N within its territorial borders.

13. A method as recited in claim 10 wherein the measure Xₙ of the value of goods and services produced by a country N is computed from a plurality of reports of Xₙ.

14. A method as recited in claim 13 wherein Xₙ for a country N is the numerical average of a plurality of reports of Xₙ.

15. A method as recited in claim 13 wherein Xₙ for a country N is a weighted average obtained from a plurality of reports of Xₙ.

16. A method as recited in claim 10 further comprising investing within predefined asset classes such that the percentage investment in specific asset class A in country N is approximately equal to the percentage that asset class A contributes to Xₙ.

17. A method as recited in claim 16 wherein the asset classes are selected from the group consisting of equity investments, fixed income investments, real estate and precious metals.

18. A method as recited in claim 10 further comprising pooling investments in those countries whose values of Xₙ fall below a pre-selected value.

19. A method as recited in claim 18 wherein the pre-selected value is a percentage of sum of Xₙ values.

20. A method as recited in claim 18 further comprising limiting the pooled investments to a pre-selected fraction of the total fund.
